(19) United States
(12) Patent Application Publication
(10) Pub. No.: US 2019/0247774 A1
(43) Pub. Date: Aug. 15, 2019

(54) DEVICE AND METHOD FOR SUPPLYING PROCESS AIR TO A TREATMENT STATION

(71) Applicant: EISENMANN SE, Böblingen (DE)

(72) Inventor: Jürgen Röckle, Magstadt (DE)

(21) Appl. No.: 16/300,574

(22) PCT Filed: Apr. 7, 2017
(86) PCT No.: PCT/EP2017/058410

§ 371 Date: Nov. 11, 2018

(30) Foreign Application Priority Data
May 12, 2016 (DE) 10 2016 005 700.9

(51) Int. Cl. B01D 46/00; B05B 14/43

(52) U.S. Cl. CPC B01D 46/009; B05B 16/60; B05B 14/43

(57) ABSTRACT

A device for supplying process air to a treatment station, the device comprising an air conducting system for delivering fresh air to the treatment station and discharging particle-loaded waste air from the treatment station, a separation system for separating the particles from the waste air, and a control unit. The separation system includes at least one filter module with at least one replaceable filter element for accepting the separated particles. The filter element includes an RFID tag and the device includes an RFID reader which is positioned in such a way that an RFID reading process can be initiated when a filter element is removed and/or inserted, and said RFID reading process can be communicated.

### BACKGROUND OF THE INVENTION

### 1. Field of the Invention

The invention relates to a device for supplying process air to a treatment station, said device comprising an air conducting system for delivering fresh air to the treatment station and discharging particle-loaded waste air from the treatment station, a separation system for separating the particles from the waste air, and a control device, wherein the separation system includes at least one filter module with at least one replaceable filter element for accepting the separated particles. The invention furthermore concerns a method for supplying process air to a treatment station.

### 2. Description of Prior Art

The mentioned devices are often used as circulation, air-supply or supply/exhaust systems for the supply of treatment stations, such as paint booths, drying systems, cooling zones, heating areas or the like, using the required process air and comprise generally one or a plurality of air filter modules with air filter elements, which can generally be replaced for the corresponding conditioning of the process air. The filter elements are offered for a filter module in various designs and, with reference to the filter grade, they are classified into different filter classes. A relevant standard for this is DIN EN 779:2012.

For the classification of a certain filter type into this classification, test dusts and test aerosols are used within the scope of a determined test procedure. However, these test procedures and test substances create laboratory conditions, which are generally not the real conditions of use. The results of this classification can therefore only allow very limited assertions to be made concerning use under real usage conditions.

There is therefore the desire to optimize filter elements, not specifically for the test conditions, but for real usage conditions. At the same time, however, there is the problem of recognizing and implementing the optimum usage parameters on the device for the respective filter element type or even the individual filter element, thereby taking advantage of maximum filter performance and filter capacity of a filter element.

### SUMMARY OF THE INVENTION

It is an object of the present invention to indicate a device and a method for supplying a treatment station with process air, which take advantage of the filter capacity and/or filter performance made available by a filter element in an optimum way during filtration and separation and holding separated particles.

This task is achieved by means of a device for supplying process air to a treatment station according to claim 1. Other embodiments of the invention are indicated within the dependent claims.

The device according to the invention for supplying a treatment station with process air comprises an air conducting system to lead fresh air to the treatment station and to remove particle-loaded air from the treatment station. In a treatment station, the air conducting system, for example, can suck waste air from a paint booth that is enriched with paint particles during a painting process or, during a drying process, organic compounds in the air.

Furthermore, the device comprises a separation system to separate the particles found in the waste air. For example, the air conducting system can supply the discharged air to a separation system from a paint booth, for example.

The device furthermore comprises a control device, which can control and/or regulate, for example, air volumes, pressure ratios, flow rates and other process parameters, for example, by controlling fans, valves, flaps or the like.

The separation system comprises at least one filter module with at least one replaceable filter element to hold the separated particles. In the case of the particles, it can involve for example an overspray occurring during a painting process or organic compounds being released during a drying process. For example, a plurality of filter modules can be arranged along a paint booth so that a section of the paint booth is assigned to one or a plurality of filter modules respectively.

The filter modules can, for example, be designed as surface filters, as depth filters or as a combination of surface and depth filters. For example, pocket and/or chamber structures can be arranged within the individual filter elements of the filter module so that a flow labyrinth is formed. Depending on the operating model, the individual filter elements can comprise a service life of one to a plurality of weeks.

According to the invention, it is provided that the filter element comprises an RFID transponder and the device comprises an RFID writing/reading unit. The RFID writing/reading unit is arranged in such a way that, if the filter element is installed in and/or removed from the filter module, an RFID reading process can be initiated and the results can be communicated to the control device. In the case of a filter element exchange performed by operating personnel, for example, the replacement process itself and/or the changes to the filter element performed when the filter is changed can be registered and reported to the control device. For example, the control device can receive information on the filter material available in the filter element via the RFID reading process in order to align the entire operation of the device with the newly inserted filter material via communication with the control device.

In the case of a preferred embodiment of the device, it can be provided that the filter element is a disposable product. For example, the filter element can at least partly comprise recycling material such as paper, cardboard, or paperboard, thereby making easy disposal possible.

A further development of the invention provides that the RFID transponder comprises data characterizing the filter element, such as a filter fleece material type, a net weight, a gross weight, a pressure drop and/or a duration of a replacement interval depending on certain usage conditions. This information is preferably stored directly on the RFID transponder, thereby making such a decentralized flow of information from the filter element to the control device possible. As an alternative, the information can also be made accessible to the control device via a central database using an individual characteristic of the filter element.

In this context, it can be provided that the data characterizing the filter element are filter-element-specific data. Therefore it is possible to characterize the filter element during or after manufacture thereof, for example, by means of measurements or based on manufacturing specific data. These data can characterize a certain filter element type or even, in particular, each individual filter element, thereby making it possible, for example, to take optimally advantage of the filter capacity available within the filter element, thereby being able to keep the filter element replacement interval as great as possible. As an alternative or simultaneously, in the case of there being a plurality of filter elements within a device, the filter element replacement intervals can be displayed by the control device with the knowledge of the individual overall filter capacities and the current filter residual capacities so that an especially favorable filter element replacement can take place for the device's operation.

In the case of a further embodiment of the invention, it can be provided that the RFID reading unit is designed as a portal, through which the filter element is mandatorily conveyed when being replaced. Under “portal”, not the construction, but the functionality comparable to a barrier should primarily be understood. This means that, when passing a filter element through the portal, it is possible for the RFID reading unit to carry out a reading process on the RFID transponder of the filter element.

In this connection, it can be provided that, in the case of mandatorily conveying a filter element through the portal, a reading process can be triggered and the result of the reading process can be communicated to the control device. Therefore, it is for example not necessary for the operating personnel performing the filter replacement to log, register or record the filter element replacement in any form since the filter element replacement can be recognized without further ado due to the mandatorily triggered reading process, thereby being communicated to the control device.

A specific embodiment of the invention provides that the at least one filter module is arranged in a filter space belonging to the device and the portal is arranged near an access point to the filter space or within a pathway leading to the access point. By means of these constructional measures, triggering an RFID reading process when replacing a filter element and thereby, for example, transmitting filter element data to the control device are securely ensured.

Favorably, the control device is set up to register a filter element being replaced and/or data that can be attributed to the filter element. Thereby, the data pertaining to the filter element can be easily supplied to the control device and, in the case of controlling/regulating the device, the data can flow through the control device.

The task is also achieved by means of a method for supplying process air to a treatment station. The method according to the invention comprises the steps of reading in information of an RFID transponder of a filter element and adapting process parameters depending on the information read in. Thereby, by means of the method according to the invention, the information related to a filter element can be used in controlling a treatment station. The information relating to the filter element can be data characterizing the filter element, such as a filter fleece material type, a net weight, a gross weight, a pressure drop and/or a duration of a replacement interval depending on certain usage conditions. This information is preferably stored directly on the RFID transponder, thereby making a decentralized flow of information from the filter element to the control device possible. As an alternative, a central database can also make information accessible via an individual characteristic of the filter element.

In the case of a favorable embodiment of the method, it can be provided that the step of reading in the information occurs when the filter element is moved within the scope of replacing the filter element. In addition to the initial registration of filter element data when using the filter element, this also makes a registration of data possible when removing the filter element. Thereby, for example, also the duration of use of the individual filter element can allow for important conclusions pertaining to the operation of the treatment station as a whole or individual sections of the station. For example, an increased frequency of change of a single filter element at a specific position within the treatment station can offer conclusions about a possible optimization potential. For example, in the case of a paint station, a particularly frequent replacement of a certain filter element may indicate that an excess amount of overspray accrues at the position of the paint station assigned to the filter element.

In the case of an embodiment of the method, it can be provided that the step of adapting process parameters comprises the adaptation of air volume, a pressure ratio and/or a flow rate.

### BRIEF DESCRIPTION OF THE DRAWINGS

Subsequently, exemplary embodiments of the invention will be explained in more detail using the drawings.

The figures show:

FIG. 1 a schematic representation of a first embodiment of a supply/exhaust device for a cooling zone and

FIG. 2 a perspective view of the embodiment of FIG. 1.

### DESCRIPTION OF PREFERRED EXEMPLARY EMBODIMENTS

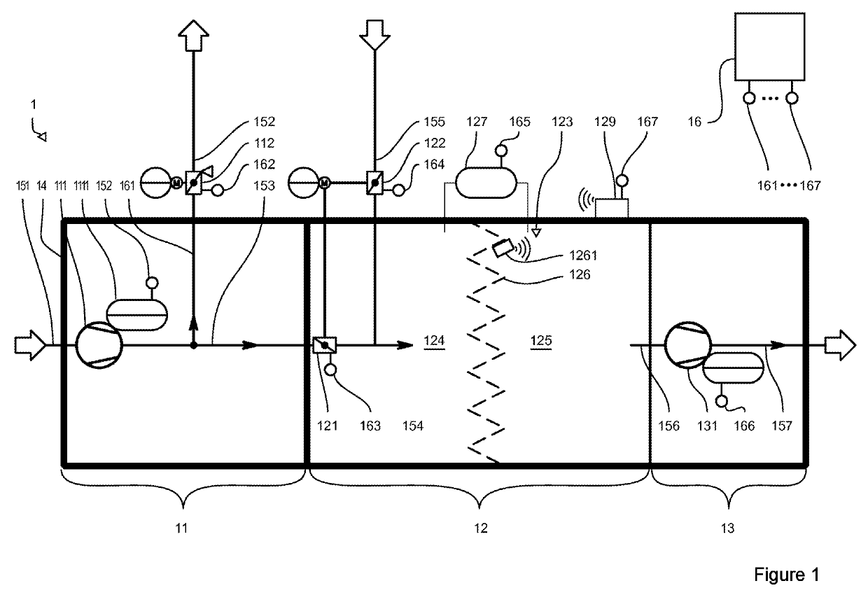

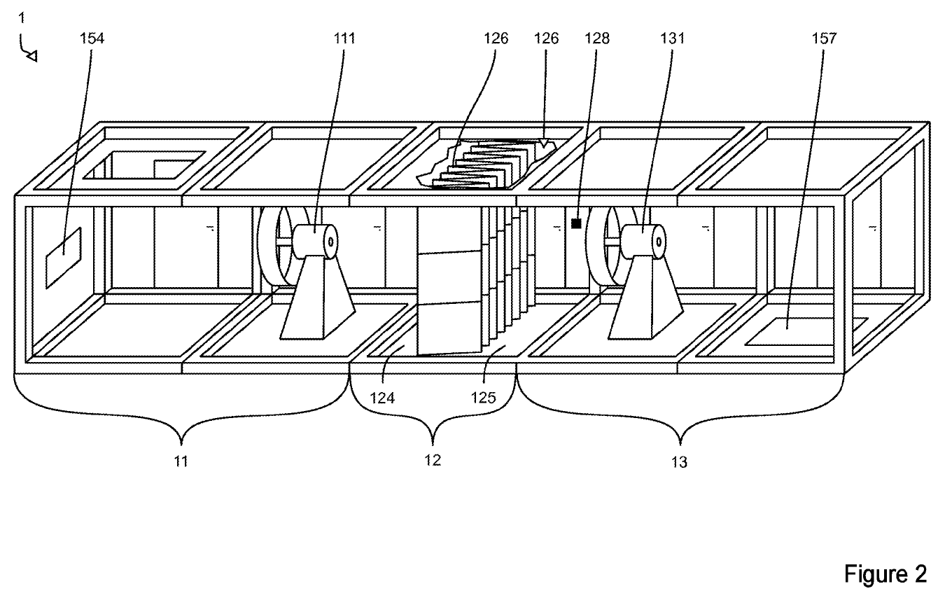

FIG. 1 shows a schematic representation of the functional aspects of a supply/exhaust device 1, while FIG. 2 shows a perspective view of the constructional aspects of the supply/exhaust device 1.

The supply/exhaust device 1 shown in FIGS. 1 and 2 can be broken down into an exhaust module 11, a filter module 12, and an air-supply module 13, which are connected both on a constructional level to a joint housing 14 as well as to each other via an air conducting system 15. The air conducting system 15 shown in the figures can, for example, be composed of pipes, channels or shafts. Air conducting can, however, also only be implemented by constructional measures, such as inner walls for example. In addition, the supply/exhaust device 1 comprises a control device 16.

The supply/exhaust device 1 represents a simple embodiment for illustrating the inventive idea, where a plurality of details have been left out for the sake of clarity. The supply/exhaust device 1 can be part of a larger station, such as a station for cooling objects, such as car bodies, however, it can also be used as a separate station. The inventive idea can also be applied in the case of a filter system to separate overspray, which accrues during the painting of car bodies for example.

The exhaust module 11 of the supply/exhaust device 1 comprises an exhaust fan 111 with a frequency regulation system 1111 as well as a related outer flap 112 arranged on top. Both the exhaust fan 111 as well as the outer flap 112 are connected to the control device 16 via control-line connections 161, 162. In order to keep FIG. 1 clear, instead of continuous control lines on the corresponding components, only control-line connections are shown, thereby being provided with corresponding reference numbers. This concerns both the control device 16 as well as the components connected to it. Naturally, in addition to the control-line connections shown, others can even be available (not shown). The control-line connections can be designed both for control as well as for regulation and enable the sending and/or receiving of data and/or related signals.

Used process air of a treatment station (not shown), referred to here as waste air, is supplied to the exhaust module 11 via an exhaust module supply line 151 by means of the exhaust fan 111. A part of this waste air is discharged into the ambient environment. In addition, an exhaust line 152 leads out of the exhaust module 11 into the ambient environment. The air volume discharged via the exhaust line 152 can be controlled by the control device 16 by means of a control-line connection 162 via the exhaust flap 112 integrated into the exhaust line 152. The exhaust flap 112 can be operated in a motorized manner, for example. Another part of the waste air led via the exhaust module supply line 151 is discharged as circulating air via a circulating line 153 to a filter module supply line 154 of the filter module 12.

The volumetric flow conveyed via the filter module supply line 154 can be controlled and regulated via an air-supply flap 121 connected to the control device 16 via a control connection 163. An outside-air supply line 155 makes the inflow of fresh outside air into the air-conducting system 15 possible. For this purpose, the outside-air supply line 155 is provided with an outside-air flap 122, which can be adjusted via the control device 16 by means of a control connection 164.

The filter module 12 comprises a filter module interior space 123 with a filter element supply-flow area 124 and a filter area discharge-flow area 125. A filter element 126, where flow takes place from the filter element supply-flow area 124 to the filter element discharge-flow area 125, is arranged between the filter element supply-flow area 124 and the filter element discharge-flow area 125. By means of a differential pressure gauge 127, which is connected to the control device 16 via a control line 165, the pressure drop across the filter element 126 can be measured.

The filtered air is conveyed from the filter element discharge-flow area 125 into the air-supply module 13 via an air-supply-module supply line 156. The air-supply-module supply line 156 is connected to a frequency-regulated air-supply ventilator 131, which, in turn, can discharge the now filtered air to a treatment station as process air via an air-supply-module discharge line 157. The air-supply ventilator 131 is connected to the control device 16 via a control connection 166 to regulate the conveyed air volume.

In the filter module 12, an access point 128 is provided, which is designed as a door in the present embodiment in FIG. 2. Naturally, other access-point types can also be provided, such as a flap, a curtain or the like. The access point 128 is provided with an RFID reading unit 129, which is connected to the control device 16 via a control-line connection 167.

The filter element 126 comprises an RFID transponder 1261. In the present embodiment, the access point 128 is designed in such a way that only one filter element 126 can be simultaneously conveyed through the access point 128. The access point 128 thereby forms an RFID portal to some extent. In the case of other embodiments, it can also be provided that a plurality of filter elements can be conveyed simultaneously through an access point.

The filter element 126 is designed as a single piece in the embodiment shown in FIG. 2. Of course, other embodiments are also conceivable, in which a plurality of filter modules can be provided per supply/exhaust device 1 and also a plurality of filter elements can be provided for each filter module.

In the present embodiment, the filter element 126 is designed as a disposable product, meaning that the filter element 126 is no longer used and is disposed of after its use. The RFID transponder 1261 can comprise data, for example, the type of the filter fleece material used, the net and/or gross weight, an initial pressure drop and/or the expected duration of a replacement interval depending on certain usage conditions, and/or, in the case of reading, transmit the data to the RFID reading unit 129. In the case of these data, they can be individual measurement data of the individual filter element 126. As an alternative, these data can be target values of a certain filter element type.

The RFID reading unit 129 is designed in such a way that it mandatorily triggers a reading process of the RFID transponder 1261 attached to a filter element 126 when it is conveyed past the filter element 126. As an alternative, it can be provided that, prior to a reading process, the RFID reading unit 129 has to be initially activated. The data that are read from the RFID transponder 1261 during the reading process can be sent to the control device 16 via the control-line connection 167.

The control device 16 is set up in such a way that the operation of the supply/exhaust device 1 is controlled depending on the data which have been read from the RFID transponder 1261 of the filter element 126 via the reading unit 129. In this way, for example, the waste air led via the exhaust module supply line 151 can be controlled via the rotational speed of the exhaust fan 111 depending on the type of filter element 126 used.

Furthermore, after exchanging a filter element 126, the type of filter element 126, the duration of use as well as the usage conditions can be logged by the reading unit 129 by means of automatic registration. An evaluation of these data makes an optimization of the service life of a filter element 126 possible, for example, depending on the filter material used in connection with the usage conditions, such as the type of the particles to be filtered.

What is claimed is:

1. A device for supplying process air to a treatment station, comprising:
an air conducting system to supply fresh air to a treatment station and to discharge particle-loaded waste air from the treatment station,
a separation system to separate the particles found in the particle-loaded waste air, and
a control device, wherein
the separation system comprises at least one filter module with at least one replaceable filter element to hold the separated particles, further wherein
the at least one replaceable filter element comprises an RFID transponder and the device comprises an RFID reading unit, wherein the RFID reading unit is arranged in such a way that an RFID reading process can be initiated when a filter element is installed and/or removed and can be communicated to the control device.

2. The device as claimed in claim 1, wherein the at least one replaceable filter element is a disposable product.

3. The device as claimed in claim 1, wherein the RFID transponder comprises data characterizing the at least one replaceable filter element, the data including one or more of a filter fleece material type, a net weight, a gross weight, a pressure drop and/or the duration of a replacement interval depending on certain usage conditions.

4. The device as claimed in claim 3, wherein the data characterizing the at least one replaceable filter element is filter-element-specific data.

5. The device as claimed in claim 1, wherein the RFID reading unit is designed as a portal, through which the at least one replaceable filter element is mandatorily moved when the at least one replaceable filter element is replaced.

6. The device as claimed in claim 5, wherein the portal is set up so that a reading process is triggered and a result of the reading process is communicated to the control device when the at least one replaceable filter element is mandatorily moved through the portal.

7. The device as claimed in claim 1, wherein the at least one filter module is arranged in a filter space belonging to the device and a portal is arranged near an access point to the filter space or within a pathway leading to the access point.

8. The device as claimed in claim 1, wherein the control device is set up to register a filter element being exchanged and/or register data that can be attributed to the filter element.

9. A method for supplying process air to a treatment station, comprising the steps:
reading-in of information of an RFID transponder of a filter element; and
adapting process parameters depending on the information read-in from the RFID transponder.

10. The method as claimed in claim 9, wherein the step of reading in the information takes place when the filter element moves within the scope of replacing the filter element.

11. The method as claimed in claim 9, wherein the step of adapting process parameters comprises the adaptation of an air volume, a pressure ratio and/or a flow rate.

12. The device as claimed in claim 5, wherein the at least one filter module is arranged in a filter space belonging to the device and the portal is arranged near an access point to the filter space or within a pathway leading to the access point.
